(19) United States
(12) Patent Application Publication
(10) Pub. No.: US 2007/0291885 A1
(43) Pub. Date: Dec. 20, 2007

(54) Asynchronous sampling system

(76) Inventors: Marlin Viss, Santa Rosa, CA (US); Ross Cole, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/453,749

(22) Filed: Jun. 15, 2006

(51) Int. Cl. H04L 7/00

(52) U.S. Cl. 375/355

(57) ABSTRACT

A signal sampling system is presented. A first sampler samples a signal under test. At least one signal generator generates an asynchronous signal that is asynchronous to the signal under test. A second sampler samples a synchronous signal that is synchronous to the signal under test. A third sampler samples the synchronous signal. In response to the at least one asynchronous signal, the first sampler obtains a first sample, the second sampler obtains a second sample and the third sampler obtains a third sample. The first sample is a data sample of the signal under test. The second sample and the third sample are used to provide timing information about the data sample.

### BACKGROUND

Equivalent-time sampling systems, such as those within oscilloscopes, are used to reconstruct the waveforms of electrical and optical signals. Within an equivalent-time sampling system, samples of a signal under test are acquired by a sampler. A time base within the equivalent-time sampling system establishes the timing of acquired samples. This allows reconstruction of a waveform of an applied signal. The reconstruction of the waveform can be displayed or stored for later use.

In addition to the signal under test, a trigger signal is also supplied to the equivalent-time sampling system. The trigger signal is in some way synchronous to the signal under test. An edge detecting circuit within the equivalent-time sampling system detects trigger events within the trigger signal. After the occurrence of a trigger event and after a controlled but variable delay, the signal under test is sampled. The captured sample has a known timing relationship to the trigger event. In this way, the equivalent-time sampling system can reconstruct a signal under test that is periodic (such as bit sequences) as well as reconstruct a signal under test that is repeating but aperiodic.

The edge detecting circuit within the equivalent-time sampling system and the circuitry that provides the variable delay can introduce timing jitter. Also, there is typically a time delay between the trigger event and the time of the actual sample that can be on the order of 24 nanoseconds (ns). Since the trigger event is sampled, if the periodicity of the signal under test is not very stable, the signal under test may appear to have more jitter relative to the trigger signal than actually exists.

In another type of equivalent-time sampling system, a quadrature clock is used in place of the trigger signal. The quadrature clock is synchronous to the signal under test. Two quadrature channels are sampled at the same time as the signal under test. The timing information is obtained from the sampling of the two channels of the quadrature clock, thus all timing is relative to one period of the quadrature clock. This approach has the advantage of lower jitter. However, it is not always convenient to provide a clean quadrature clock to an equivalent-time sampling system

### SUMMARY OF THE INVENTION

In accordance with embodiments of the present invention, a signal sampling system is presented. A first sampler samples a signal under test. At least one signal generator generates at least one asynchronous signal that is asynchronous to the signal under test. A second sampler samples a synchronous signal that is synchronous to the signal under test. A third sampler samples the synchronous signal. In response to the at least one asynchronous signal, the first sampler obtains a first sample, the second sampler obtains a second sample and the third sampler obtains a third sample. The first sample is a data sample of the signal under test. The second sample and the third sample are used to provide timing information about the data sample.

### BRIEF DESCRIPTION OF THE DRAWINGS

FIG. 1 shows a block diagram of an asynchronous sampling system in accordance with an embodiment of the present invention.

FIG. 2 is a simplified flowchart describing operation of the asynchronous sampling system shown FIG. 1 in accordance with an embodiment of the present invention.

FIG. 3 shows a block diagram of an asynchronous sampling system in accordance with another embodiment of the present invention.

FIG. 4 shows a block diagram of an asynchronous sampling system in accordance with another embodiment of the present invention.

FIG. 5 shows a block diagram of a time establishing sampler system within an asynchronous sampling system in accordance with another embodiment of the present invention.

FIG. 6 shows a block diagram of a time establishing sampler system within an asynchronous sampling system in accordance with another embodiment of the present invention.

### DESCRIPTION OF THE EMBODIMENT

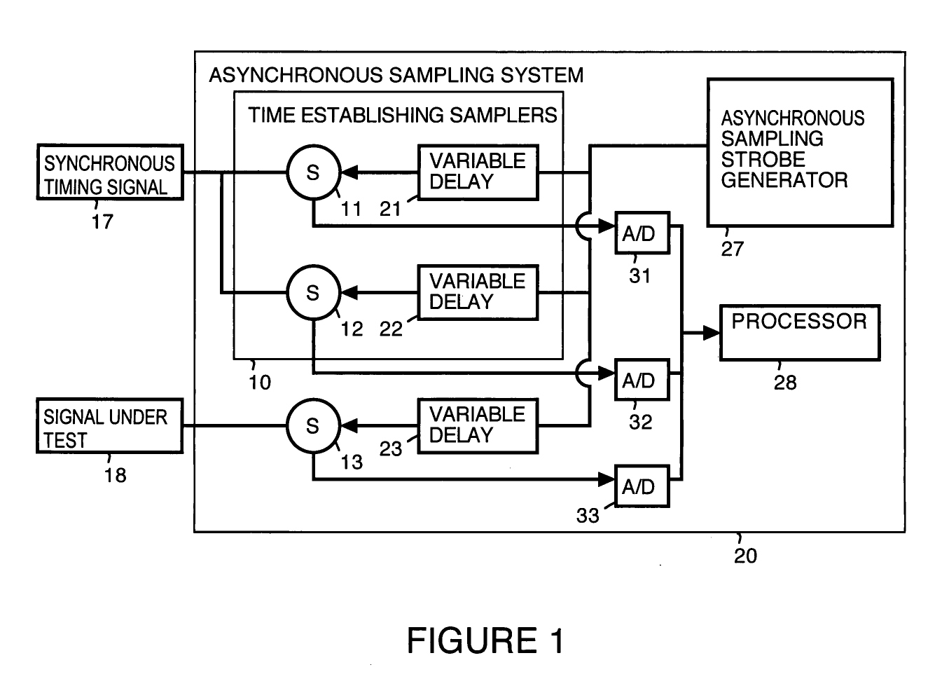

FIG. 1 shows a block diagram of an asynchronous sampling system 20. Asynchronous sampling system 20 receives a synchronous timing signal 17 and a signal under test 18. Time establishing samplers 10 establish timing of the signal under test 18 using synchronous timing signal 17. Time establishing samplers 10 include a sampler 11 with associated variable delay 21, and a sampler 12 with an associated variable delay 22.

A sampler 13 samples signal under test 18 at a time based on strobe signals from an asynchronous sampling strobe generator 27 and a variable delay 23. Asynchronous sampling strobe generator 27 also provides a strobe signal to variable delay 21 and variable delay 22. The strobe signal that asynchronous sampling strobe generator 27 provides to variable delay 21, variable delay 22 and variable delay 23 is asynchronous to signal under test 18. Samples from sampler 11 are converted from an analog signal to a digital signal by an analog-to-digital (A/D) converter 31. Samples from sampler 12 are converted from an analog signal to a digital signal by an A/D converter 32. Samples from sampler 13 are converted from an analog signal to a digital signal by an A/D converter 33. A processor 28 receives signals from A/D converter 31, A/D converter 32 and A/D converter 33. Processor 28 also controls the amount of delay in each of variable delay 21, variable delay 22 and variable delay 23 as well as the timing of asynchronous sampling strobe generator 27. Each of samplers 11 through 13 is, for example, a sampler similar to that disclosed in U.S. Pat. No. 4,956,568 or another type of sampler as is selected to be optimal for a particular application.

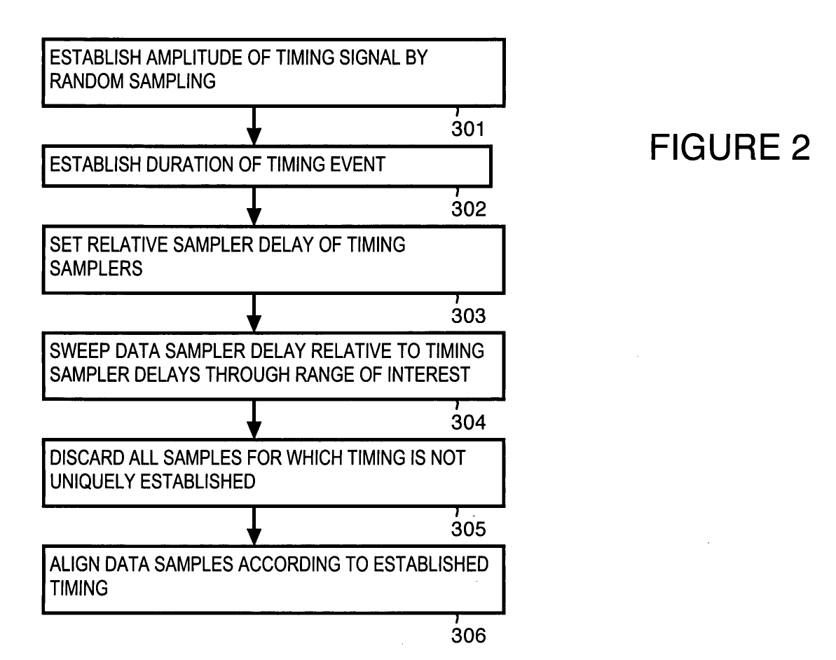

FIG. 2 is a simplified flowchart describing how processor 28 oversees sampling of signal under test 18. In a block 301, processor 28 establishes the amplitude of synchronous timing signal 17 by using sampler 11 and/or sampler 12 to take several samples of synchronous timing signal 17. Block 301 is optional as in many implementations it is not necessary to establish the amplitude of synchronous timing signal 17.

In a block 302, the duration of a timing event is determined. For example, the timing event may be the leading edges of pulses from the synchronous timing signal 17. Alternatively, the timing event may be the trailing edges of pulses within synchronous timing signal 17 or some other timing event within synchronous timing signal 17.

For example, when the timing event is the rising edge of a pulse within synchronous timing signal 17, the duration of each timing event is equal to the risetime of the rising edge of each pulse. The duration of the timing event is established by sweeping timing of variable delays 21 and 22 while obtaining samples from sampler 11 and sampler 12. From the acquired samples, the maximum rate (dV/dt) of the rising edge of each pulse of synchronous timing signal 17 is tracked. From monitoring this, the duration of the risetime (which is the duration of the timing event) is established. Duration of the timing event when the timing event is other than the rising edge of a pulse, can be established in a similar manner.

In a step 303, processor 28 sets the relative sampler delay within time establishing samplers 10. For example, processor 28 sets the delay duration of variable delay 21 and variable delay 22 so that the time between when sampler 11 samples synchronous timing signal 17 and when sampler 12 samples synchronous timing signal 17 is equal to one half the timing event established in block 302. Alternatively, processor 28 can set the delay duration of variable delay 21 and variable delay 22 so that the time between when sampler 11 samples synchronous timing signal 17 and when sampler 12 samples synchronous timing signal 17 is some other value; however, typically processor 28 will set the delay duration of variable delay 21 and variable delay 22 so that the time between when sampler 11 samples synchronous timing signal 17 and when sampler 12 samples synchronous timing signal 17 is less than the timing event established in block 302.

In a block 304, processor 28 receives samples from sampler 11, sampler 12 and sampler 13, where a delay duration produced by variable delay 23 is swept throughout a predetermined range relative to delay duration values of variable delay 21 and variable delay 22. For each timing event of asynchronous sampling strobe generator 27, a sampling triplet consisting of a sample from each of sampler 11, sampler 12 and sampler 13 is received by processor 28.

In a block 305, each sampling triplet for which timing relative to synchronous timing signal 17 is not uniquely established is discarded. For example, when the timing event is the rising edge of pulses within synchronous timing signal 17, timing relative to synchronous timing signal 17 can be uniquely established when the value of samples received from sampler 11 and sampler 12 indicate that both samples were taken during the rising edge of a pulse. Alternatively, depending upon the consistency and clarity of pulses within synchronous timing signal 17, it may be possible to uniquely establish the timing relative to synchronous timing signal 17 for a sampling triplet whenever the voltage value of a sample received from sampler 11 is a predetermined amount less (or greater) than the voltage value of a sample received from sampler 12.

For sampling triplets not thrown away in block 305, it is possible to uniquely determine timing for the sampling triplet relative to synchronous timing signal 17. In a block 306, for sampling triplets not thrown away in block 305, the sampling data from sampler 13 and the timing data from samplers 11 and 12 are used to provide-a value of signal under test 18 for an established time within the cycle of synchronous timing signal 17. The resulting samples of signal under test 18 can be aligned to reconstruct signal under test 18. The alignment can be done, for example, using interpolation.

While FIG. 1 shows use of a separate synchronous timing signal 17 in addition to signal under test 18, in an alternative embodiment, the signal under test can also be used as the synchronous timing signal. In this case, the simplified flowchart shown in FIG. 2 is changed only in that the signal under test is used instead of a separate synchronous timing signal to establish timing.

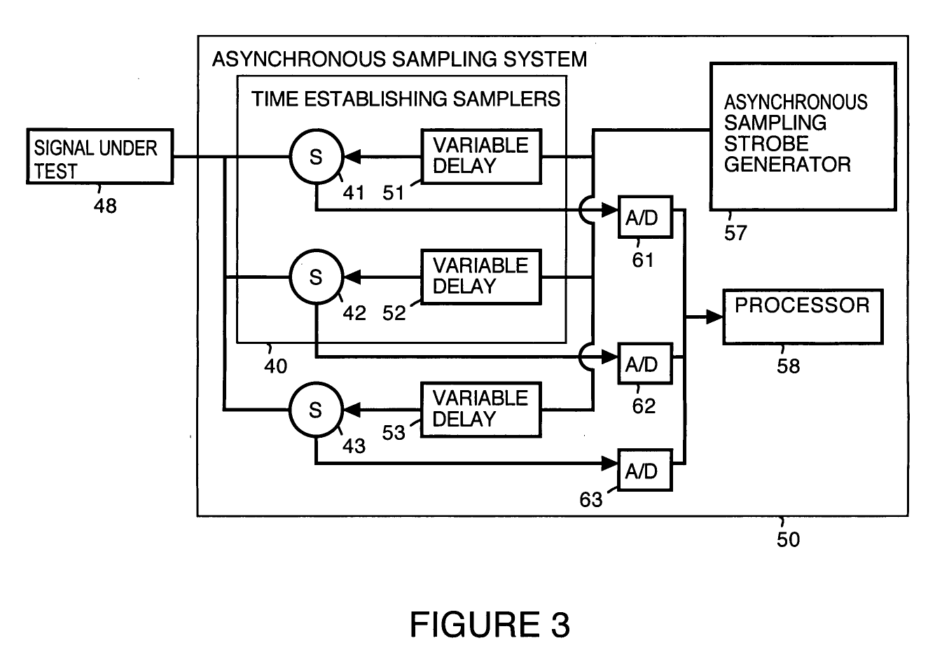

For example, FIG. 3 shows a block diagram of an asynchronous sampling system that does not use a separate synchronous timing signal in addition to a signal under test, but instead the signal under test is used to establish timing.

FIG. 3 shows a block diagram of an asynchronous sampling system 50. Asynchronous sampling system 50 receives a signal under test 48. Time establishing samplers 40 establish timing of the signal under test 48 using signal under test 48. Time establishing samplers 40 include a sampler 41 with associated variable delay 51, and a sampler 42 with an associated variable delay 52.

A sampler 43 samples signal under test 48 at a time based on strobe signals from an asynchronous sampling strobe generator 57 and a variable delay 53. Asynchronous sampling strobe generator 57 also provides a strobe signal to variable delay 51 and variable delay 52. The strobe signal that asynchronous sampling strobe generator 57 provides to variable delay 51, variable delay 52 and variable delay 53 is asynchronous to signal under test 48. Samples from sampler 41 are converted from an analog signal to a digital signal by an A/D converter 61. Samples from sampler 42 are converted from an analog signal to a digital signal by an A/D converter 62. Samples from sampler 43 are converted from an analog signal to a digital signal by an A/D converter 63. A processor 58 receives signals from A/D converter 61, A/D converter 62 and A/D converter 63. Processor 58 also controls the amount of delay in each of variable delay 51, variable delay 52 and variable delay 53 as well as the timing of asynchronous sampling strobe generator 57.

In the embodiment shown in FIG. 3, sampler 43, in addition to sampler 41 and sampler 42, can be used when establishing the duration of the timing event. Also, when sweeping the data sampler delay, for non-discarded samples, the values detected by the time establishing samplers 41 and 42 be used as data samples in addition to the data sample obtained by sampler 43.

In alternative embodiments of the present invention, the number of samplers can be varied. In addition, a filter can be added before the time establishing samplers to expand the timing event.

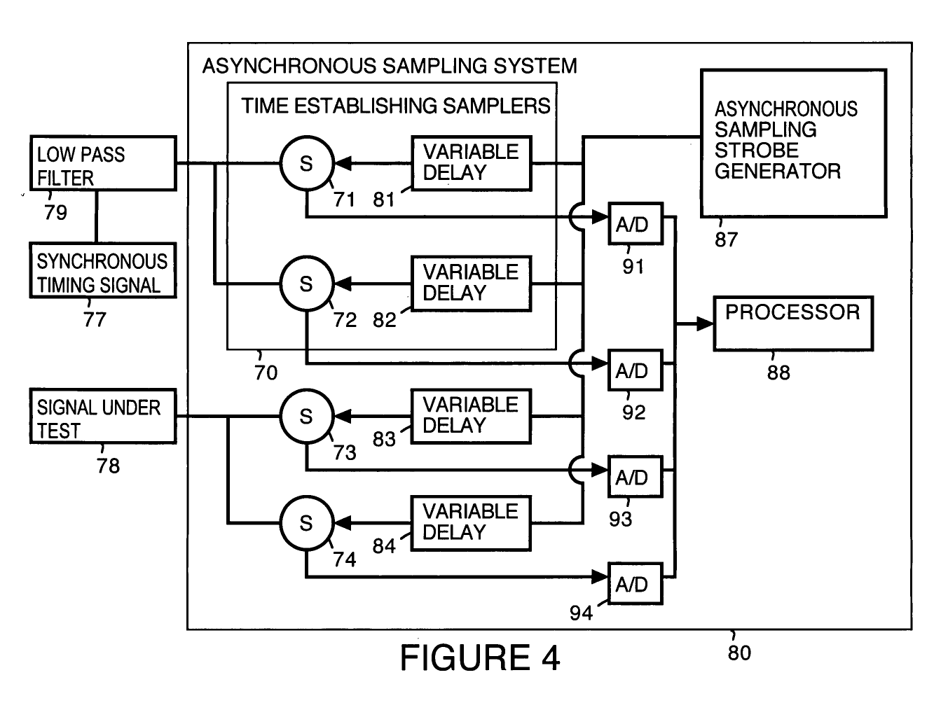

For example, FIG. 4 shows a block diagram of an asynchronous sampling system 80. Asynchronous sampling system 80 receives a synchronous timing signal 77 and a signal under test 78. A low pass filter 79, used to expand the timing of synchronous timing signal 77, can be located within or external to asynchronous sampling system 80. Time establishing samplers 70 establish timing of the signal under test 78 using synchronous timing signal 77 as filtered by low pass filter 79. Time establishing samplers 70 include a sampler 71 with associated variable delay 81, and a sampler 72 with an associated variable delay 82.

A sampler 73 samples signal under test 78 at a time based on strobe signals from an asynchronous sampling strobe generator 87 and a variable delay 83. A sampler 74 samples signal under test 78 at a time based on strobe signals from asynchronous sampling strobe generator 87 and a variable delay 84. Asynchronous sampling strobe generator 87 also provides a strobe signal to variable delay 81 and variable delay 82. The strobe signal that asynchronous sampling strobe generator 87 provides to variable delay 81, variable delay 82 variable delay 83 and variable delay 84 is asynchronous to signal under test 78. Samples from sampler 71 are converted from an analog signal to a digital signal by an A/D converter 91. Samples from sampler 72 are converted from an analog signal to a digital signal by an A/D converter 92. Samples from sampler 73 are converted from an analog signal to a digital signal by an A/D converter 93. Samples from sampler 74 are converted from an analog signal to a digital signal by an A/D converter 94. A processor 88 receives signals from A/D converter 91, A/D converter 92 and A/D converter 93. Processor 88 also controls the amount of delay in each of variable delay 81, variable delay 82, variable delay 83 and variable delay 84 as well as the timing of asynchronous sampling strobe generator 87.

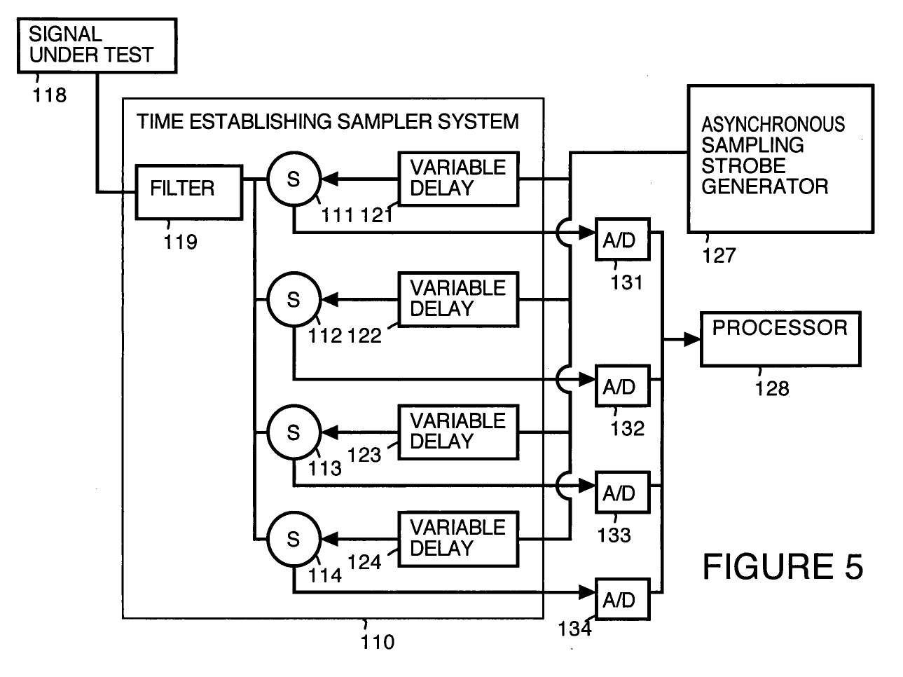

For example, FIG. 5 shows a block diagram of time establishing samplers 110. In FIG. 5, data samplers within an asynchronous sampling system that includes time establishing samplers 110 are not shown. Time establishing samplers 110 receive signal under test 118. A low pass filter 119, used to expand the timing of signal under test 118, can be located within or external to time establishing samplers 110, provided that any data samplers within an asynchronous sampling system that includes time establishing samplers 110 receive signal under test 118 before signal under test 118 is filtered by low pass filter 119. Time establishing samplers 110 establish timing of the signal under test 118 using signal under test 118 as filtered by low pass filter 119. Time establishing samplers 110 include a sampler 111 with associated variable delay 121, a sampler 112 with an associated variable delay 122, a sampler 113 with an associated variable delay 123 and a sampler 114 with an associated variable delay 124.

An asynchronous sampling strobe generator 127 provides a strobe signal to variable delay 121, variable delay 122, variable delay 123 and variable delay 124. The strobe signal that asynchronous sampling strobe generator 127 provides to variable delay 121, variable delay 122, variable delay 123 and variable delay 124 is asynchronous to signal under test 118. Samples from sampler 111 are converted from an analog signal to a digital signal by an A/D converter 131. Samples from sampler 112 are converted from an analog signal to a digital signal by an A/D converter 132. Samples from sampler 113 are converted from an analog signal to a digital signal by an A/D converter 133. Samples from sampler 114 are converted from an analog signal to a digital signal by an A/D converter 134. A processor 128 receives signals from A/D converter 131, A/D converter 132 and A/D converter 133. Processor 128 also controls the amount of delay in each of variable delay 121, variable delay 122, variable delay 123 and variable delay 124 as well as the timing of asynchronous sampling strobe generator 127.

In alternative embodiments of the present invention, each sampler can use a separate strobe to provide a sampling trigger. This allows flexibility in using different timing characteristics. For example, separately controlling the sampling aperture used by each of samplers allows flexibility in the sampling duration at which each sampler performs samples. For example, for a typical linear feedforward equalizer, each time an input signal is sampled, it is sampled for a uniform sampling duration. In this case, the sampling apertures used by samplers can be adjusted to allow for each sample duration to be equal. On the other hand, for some applications, it is desirable to vary the sampling duration so that different samplers take samples at different sampling durations. For such applications, the sampling apertures used by the samplers can be varied to achieve optimal and varied sampling durations. For example, sampling aperture is controlled by the width of a pulse used to trigger a sampler to obtain a sample. The wider the width of the pulse, the longer the duration during which a sampler obtains a sample. The smaller the width of the pulse, the shorter the duration during which a sampler obtains a sample.

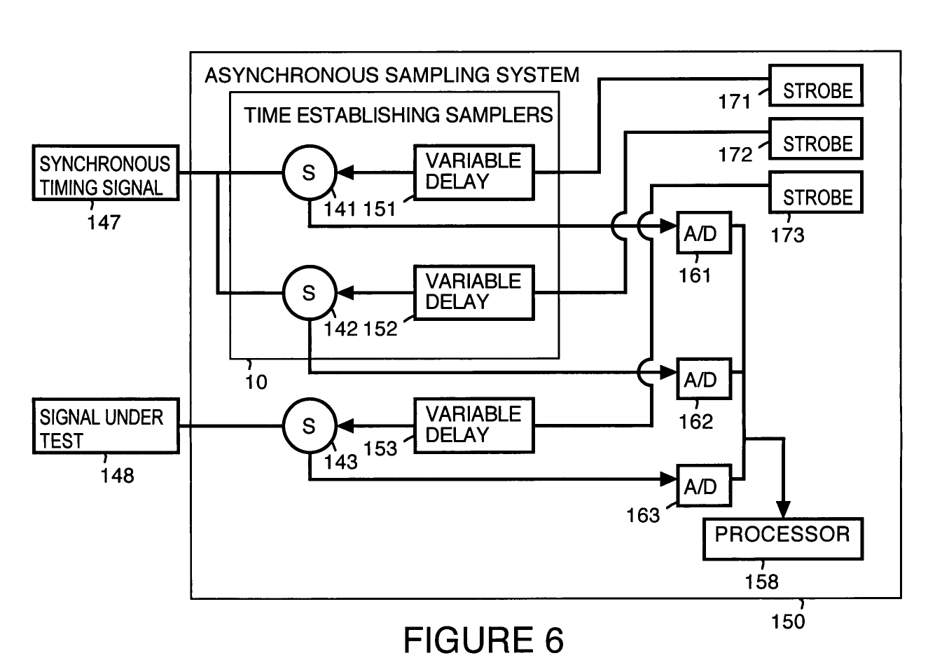

FIG. 6 shows a block diagram of an asynchronous sampling system 140 where a separate strobe is used for each sampler, allowing use of different timing characteristics when obtaining samples. Asynchronous sampling system 150 receives a synchronous timing signal 147 and a signal under test 148. Time establishing samplers 140 establish timing of the signal under test 148 using synchronous timing signal 147. Time establishing samplers 140 include a sampler 141 with associated variable delay 151, and a sampler 142 with an associated variable delay 152.

A sampler 143 samples signal under test 148 at a time based on strobe signals from a strobe generator 173 and a variable delay 153. A strobe generator 171 provides a strobe signal to variable delay 151. A strobe generator 172 provides a strobe signal to variable delay 152. The strobe signals generated by strobe generator 171, strobe generator 172 and strobe generator are synchronous to each other, but asynchronous to signal under test 148. Variable delay 151, variable delay 152 and variable delay 153 are optional, as the needed variable delay can also be generated by varying the timing of strobes from strobe generator 171, strobe generator 172 and strobe generator 173, respectively.

Samples from sampler 141 are converted from an analog signal to a digital signal by an analog-to-digital (A/D) converter 161. Samples from sampler 142 are converted from an analog signal to a digital signal by an A/D converter 162. Samples from sampler 143 are converted from an analog signal to a digital signal by an A/D converter 163. A processor 158 receives signals from A/D converter 161, A/D converter 162 and A/D converter 163. Processor 158 also controls the amount of delay in each of variable delay 151, variable delay 152 and variable delay 153 as well as separately controlling the timing characteristics of each of strobe 171, strobe 172 and strobe 173.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A signal sampling system comprising:
a first sampler that samples a signal under test;
at least one signal generator that generates at least one asynchronous signal that is asynchronous to the signal under test;
a second sampler that samples a synchronous signal that is synchronous to the signal under test;
a third sampler that samples the synchronous signal; and,
wherein in response to the at least one asynchronous signal, the first sampler obtains a first sample, the second sampler obtains a second sample and the third sampler obtains a third sample, the first sample being a data sample of the signal under test, the second sample and the third sample being used to provide timing information about the data sample.

2. A signal sampling system as in claim 1 wherein the synchronous signal is the signal under test.

3. A signal sampling system as in claim 1 wherein the synchronous signal is not the signal under test.

4. A signal sampling system as in claim 1 wherein the at least one asynchronous signal is a single asynchronous signal, and wherein the signal sampling system additionally comprises:
a first variable delay that delays the single asynchronous signal before the single asynchronous signal is received by the first sampler;
a second variable delay that delays the single asynchronous signal before the single asynchronous signal is received by the second sampler; and,
a third variable delay that delays the single asynchronous signal before the single asynchronous signal is received by the third sampler.

5. A signal sampling system as in claim 1 wherein the synchronous signal passes through a low pass filter before reaching the second sampler and the third sampler, the low pass filter expanding a timing event within the synchronous signal.

6. A signal sampling system as in claim 1 additionally comprising:
a fourth sampler that samples the signal under test.

7. A signal sampling system as in claim 1 additionally comprising:
a fourth sampler that samples the synchronous signal.

8. A method for sampling a signal under test comprising:
performing the following in response to at least one asynchronous signal that is asynchronous to the signal under test:
obtaining a first sample of the signal under test;
obtaining a second sample of a synchronous signal, the synchronous signal being synchronous to the signal under test;
obtaining a third sample of the synchronous signal;
using the first sample as a data sample of the signal under test; and,
using the second sample and the third sample to provide timing information about the data sample.

9. A method as in claim 8 wherein the synchronous signal is the signal under test.

10. A method as in claim 8 wherein the synchronous signal is not the signal under test.

11. A method as in claim 8 a separate asynchronous signal is used for obtaining each of the first sample, the second sample and the third sample.

12. A method as in claim 8 additionally comprising:
performing the following preliminary steps:
establishing a duration of a timing event within the synchronous signal; and,
setting a delay duration between obtaining the second sample and obtaining the third sample to be less than the duration of the timing event.

13. A method as in claim 8 additionally comprising:
performing the following preliminary steps:
establishing a duration of a timing event within the synchronous signal; and,
setting a delay duration between obtaining the second sample and obtaining the third sample to be half the duration of the timing event.

14. A method as in claim 8 additionally comprising:
performing the following preliminary steps:
establishing an amplitude of the synchronous signal;
establishing a duration of a timing event within the synchronous signal; and,
setting a delay duration between obtaining the second sample and obtaining the third sample to be less than the duration of the timing event.

15. A method as in claim 8 additionally comprising:
discarding the data sample when the second sample and the third sample do not uniquely establish a sampling time for the first sample with respect to the synchronous signal.

16. A signal sampling system comprising:
first means for sampling a signal under test;
signal generator means for generating at least one asynchronous signal that is asynchronous to the signal under test;
second means for sampling a synchronous signal that is synchronous to the signal under test;
third means for sampling the synchronous signal; and,
wherein in response to the at least one asynchronous signal, the first means, after a first delay, obtains a first sample, the second means, after a second delay, obtains a second sample and the third means, after a third delay, obtains a third sample, the first sample being a data sample of the signal under test, the second sample and the third sample being used to provide timing information about the data sample.

17. A signal sampling system as in claim 16 wherein the at least one asynchronous signal comprises:
a first asynchronous signal that is used to control the first means;
a second asynchronous signal that is used to control the second means; and,
a third asynchronous signal that is used to control the third means.

18. A signal sampling system as in claim 16 wherein the at least one asynchronous signal is a single asynchronous signal that is used to control the first means, the second means and the third means.

19. A signal sampling system as in claim 16 additionally comprising:
means for processing information from the first sample, the second sample and the third sample.

20. A signal sampling system as in claim 16 additionally comprising:
filtering means for filtering the synchronous signal in order to expand a timing event within the synchronous signal before the synchronous signal reaches the second means and the third means.
